(19) United States
(12) Patent Application Publication
(10) Pub. No.: US 2026/0016347 A1
(43) Pub. Date: Jan. 15, 2026

(54) Contactor with Integrated Shunt Resistor, and Method for Producing a Contactor

(71) Applicant: Bayerische Motoren Werke Aktiengesellschaft, Muenchen (DE)

(72) Inventors: Robert ALIG, Germering (DE); Michael BINDER, Unterhaching (DE); Thomas GLASS, Mainburg (DE)

(21) Appl. No.: 19/259,070

(22) Filed: Jul. 3, 2025

(30) Foreign Application Priority Data
Jul. 9, 2024 (DE) 10 2024 119 403.0

(51) Int. Cl. G01K 7/16

(52) U.S. Cl. CPC G01K 7/16

(57) ABSTRACT

A contactor has a first contact element and a second contact element as well as an electrically conductive connecting element. An actuator is designed to move the connecting element between a closed state and an open state, wherein, in the closed state, an electrically conductive connection between the first contact element and the second contact element is effected via the connecting element and, wherein, in the open state, no electrically conductive connection between the first contact element and the second contact element is effected by the connecting element. At least one measuring component of the connecting element is in the form of a measuring resistor. Measuring lines are electrically conductively connected to different ends of the measuring component so that a voltage that drops across the measuring component due to the current flowing through the measuring component can be measured via the measuring lines.

### CROSS REFERENCE TO RELATED APPLICATION

This application claims priority under 35 U.S.C. § 119 from German Patent Application No. 10 2024 119 403.0, filed Jul. 9, 2024, the entire disclosure of which is herein expressly incorporated by reference.

### BACKGROUND AND SUMMARY

The invention relates to a contactor that is efficient in terms of installation space, in particular for use in a motor vehicle. The invention furthermore relates to a method for producing a contactor.

An at least partially electrically driven vehicle typically has an electrical energy storage device which is set up to store electrical energy for the operation of an electric drive machine of the vehicle. The electrical energy storage device can comprise one or more contactors, each of which is designed to decouple a pole of the energy storage device from the memory cells of the energy storage device or to couple same to the memory cells of the energy storage device. A pole may be a positive pole, a negative pole or an intermediate tap. The energy storage device can also have one or more shunt or measuring resistors which make it possible to measure the current flowing through the corresponding one or more contactors.

This document deals with the technical problem of measuring the current flowing through a contactor in an efficient manner (in terms of installation space and/or weight).

The object is achieved by the independent claims. Advantageous embodiments are described inter alia in the dependent claims. It is pointed out that additional features of a patent claim dependent on an independent patent claim, without the features of the independent patent claim or in combination only with a subset of the features of the independent patent claim, may form a standalone invention that is independent of the combination of all of the features of the independent patent claim and may be made into the subject matter of an independent claim, a divisional application or a subsequent application. This applies in the same way to technical teachings that are described in the description and may form an invention independent of the features of the independent patent claims.

One aspect describes a contactor which comprises a first contact element and a second contact element as well as an electrically conductive connecting element (in particular a busbar). The contact elements may correspond to terminals and/or poles of the contactor. The connecting element can be arranged in a housing of the contactor.

The contactor also comprises an actuator designed to move the connecting element between a closed state and an open state. Only one (movable) part of the connecting element can be moved in order to move the connecting element between a closed state and an open state. In the closed state, an electrically conductive connection between the first contact element and the second contact element is typically effected via the connecting element. On the other hand, in the open state, no electrically conductive connection between the first contact element and the second contact element is typically effected by the connecting element.

At least or exactly one measuring component of the connecting element is in the form of a measuring resistor, in particular a shunt resistor.

The connecting element can have a fixed part and a movable part. The actuator can be designed to move the movable part of the connecting element in order to move the connecting element between the closed state and the open state. The fixed part of the connecting element can comprise the measuring component of the connecting element. In particular, the fixed part of the connecting element may correspond to the measuring component of the connecting element. A mechanically particularly stable measuring component can therefore be provided.

Alternatively, the measuring component may be formed by the entire connecting element. A particularly precise measuring resistor can therefore be provided (due to the size).

The measuring component typically comprises different ends. In particular, the measuring component typically comprises a first end and an opposite second end. The measuring component of the connecting element is preferably designed in such a way that the current flowing between the different ends, in particular between the first end and the second end, of the measuring component corresponds to, in particular equals, the current flowing between the first contact element and the second contact element.

The contactor also comprises measuring lines which are electrically conductively connected to the different ends of the measuring component so that the voltage that drops across the measuring component due to the current flowing through the measuring component can be measured via the measuring lines. In particular, the contactor can have a first measuring line which is electrically conductively connected to the first end of the measuring component. The contactor can furthermore have a second measuring line which is electrically conductively connected to the second end of the measuring component. The voltage can then be measured between the first and second measuring lines. The measuring lines can each be led out of the housing of the contactor.

The invention thus describe a contactor which has an integrated shunt resistor as part of the connecting element for the electrically conductive connection of the two contact elements of the contactor. This enables particularly efficient measurement of the current flowing through the contactor (since the connecting element is also used as a shunt resistor). It is possible to take the measured current as a basis for detecting, for example, whether or not the contactor, in particular the connecting element of the contactor, is jammed or worn.

The contactor can have a specification (by which the structure of the contactor is defined and/or documented). In the specification, the nominal value of the ohmic resistance of the measuring component of the connecting element can be specified with a certain tolerance. The specified tolerance is preferably 10% or less, in particular 5% or less, or 1% or less. Such a low tolerance can be achieved, in particular, by measuring the measuring component during the manufacture of the contactor and it only being installed in the contactor if the measurement value of the ohmic resistance of the measuring component meets the tolerance requirement. A particularly precise current measurement can be made possible by providing a measuring component with one or more specified properties (particularly with respect to the resistance of the measuring component).

The contactor can comprise a temperature sensor which is set up to record temperature measurement values in relation to the temperature of the measuring component of the connecting element. The contactor can furthermore comprise one or more temperature lines to the temperature sensor for providing the temperature measurement values of the temperature sensor (which, for example, are led out of the housing of the contactor). The accuracy of the current measurement can be increased further by measuring the temperature of the measuring component.

The contactor can comprise a temperature control unit (in particular a cooling unit) which is set up to control the temperature of, in particular to cool and/or to heat, the measuring component of the connecting element. For example, the measuring component can be temperature-controlled to a defined nominal temperature. This allows the accuracy of the current measurement to be further increased. The current carrying capacity of the contactor can also be further increased.

Another aspect describes a system which comprises a power line. The system may be part of a (motor) vehicle. The system comprises a contactor which is designed as described in this document. One section of the power line can be connected to the first contact element of the contactor, and another section of the power line can be connected to the second contact element of the contactor. The contactor can be designed to interrupt the power line by moving the connecting element of the contactor (from the closed state) to the open state.

The system can comprise a voltage measuring unit which is set up to record a voltage measurement value of the voltage on the measuring lines (in particular between the first measuring line and the second measuring line) of the contactor. The system can furthermore comprise a control unit which is set up to determine a current measurement value of the current flowing between the contact elements of the contactor (and thus via the power line) on the basis of the voltage measurement value and using characteristic data. The characteristic data can indicate a resistance value (for example the specified nominal value), determined in advance, of the ohmic resistance of the measuring component of the connecting element of the contactor. This allows the current flowing through the contactor and/or through the power line to be determined efficiently and precisely.

As already stated, the contactor can comprise a temperature sensor which is set up to record temperature measurement values in relation to the temperature of the measuring component of the connecting element. For a large number of different temperature measurement values, the characteristic data can in each case specify a resistance value of the ohmic resistance of the measuring component of the connecting element of the contactor. The control unit can be set up to determine the current measurement value (on the basis of the voltage measurement value) on the basis of the temperature measurement value and on the basis of the characteristic data. This allows the current flowing through the contactor and/or through the power line to be determined particularly precisely.

The control unit of the contactor can be set up to record a first voltage measurement value of the voltage between the first contact element of the contactor and a reference potential, for example ground. The reference potential can be applied to a reference contact element of the contactor. A first voltage measurement value of the voltage between the first contact element and the reference contact element can thus be detected.

The control unit of the contactor can furthermore be set up to record a second measured voltage value of the voltage between the second contact element of the contactor and the reference potential and/or the reference contact element.

The control unit can also be set up to take the first voltage measurement value and the second voltage measurement value as a basis for checking whether the contactor, in particular the connecting element of the contactor, is jammed. For example, it is possible to identify that the contactor is jammed if
the first voltage measurement value and the second voltage measurement value are essentially the same even though the connecting element is in the open state; or
the first voltage measurement value and the second voltage measurement value are different even though the connecting element is in the closed state.

This allows the status of the contactor to be checked efficiently and reliably.

Another aspect describes a (road) motor vehicle (in particular a passenger vehicle or a commercial vehicle or a bus or a motorcycle) that comprises the system and/or contactor described in this document.

One aspect describes a method for producing a contactor which is designed as described in this document. The method comprises selecting, from a set of possible measuring components, a measuring component of the connecting element which has an ohmic resistor with a resistance value which deviates from a predefined nominal value by no more than a predefined tolerance. The method furthermore comprises installing the selected measuring component in a contactor and
connecting different ends of the measuring component to measuring lines to record an electrical voltage dropping across the measuring component.

Alternatively or in addition to selecting a measuring component, the method can comprise measuring the resistance value of the ohmic resistance of the measuring component, and storing (in particular saving) the measured resistance value as characteristic data for the contactor. The characteristic data can, for example, be stored together with an identifier of the contactor. The stored characteristic data can then subsequently be used during operation of the contactor in order to precisely and efficiently determine a current measurement value of the current flowing between the contact elements of the contactor.

It should be noted that the methods, apparatuses and systems described in this document may be used both on their own and in combination with other methods, apparatuses and systems described in this document. Furthermore, any aspects of the methods, apparatuses and systems described in this document may be combined with one another in a wide variety of ways. The features of the claims may in particular be combined with one another in a wide variety of ways. Furthermore, features in parentheses should be understood as optional features.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows exemplary components of a vehicle;

FIGS. 2A and 2B shows exemplary contactors each with an integrated shunt resistor; and

FIG. 3 is a flowchart of an exemplary method for producing a contactor.

### DETAILED DESCRIPTION OF THE DRAWINGS

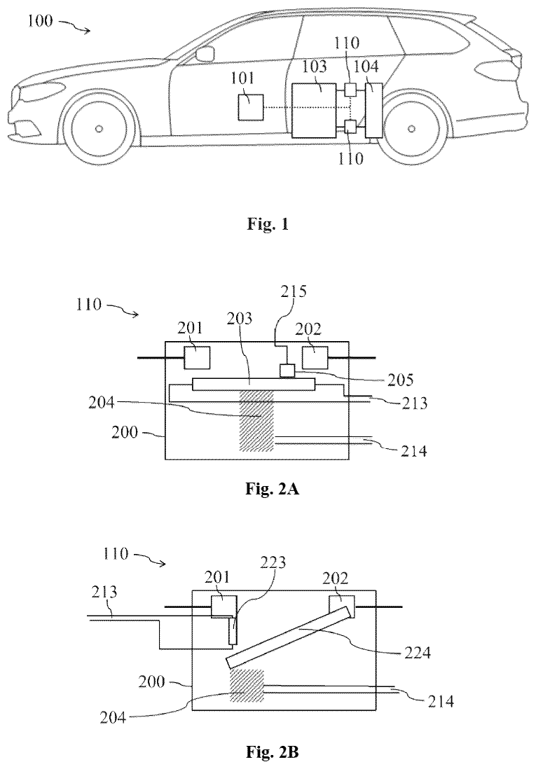

As stated at the beginning, this document deals with the efficient and precise measurement of the current through a contactor. In this context, FIG. 1 shows an exemplary vehicle 100 with an electrical energy storage device 103 which is set up to store electrical energy for the operation of an electric drive machine (not illustrated) of the vehicle 100. The energy storage device 103 can be coupled via power lines to an inverter 104 or to a charging socket (not illustrated) of the vehicle 100 in order to provide power for the operation of the drive machine or to receive charging current for charging the energy storage device 103.

The power lines can each be interrupted by an (electromechanical) contactor 110. The contactor 110 can be opened in order to interrupt the respective power line. On the other hand, the contactor 110 can be closed to allow current to flow through the contactor 110 and through the power line.

FIGS. 2A and 2B illustrate exemplary embodiments of contactors 110. A contactor 110 comprises a first contact element 201 and a second contact element 202. The contactor 110 furthermore comprises an electrically conductive connecting element 203 which is designed to electrically conductively connect the two contact elements 201, 202 to one another so that a current can flow from the first contact element 201, via the connecting element 203, to the second contact element 202 (and optionally in the reverse direction).

The contactor 100 can be designed in such a way that at least a part of the connecting element 203 can be moved by an actuator 204 in order to move the connecting element 203 between an open state and a closed state. In the open state, there is no electrically conductive contact between the connecting element 203 and at least one of the two contact elements 201, 202 (and so no current can flow between the two contact elements 201, 202 via the connecting element 203). On the other hand, in the closed state, there is electrically conductive contact between the connecting element 203 and both contact elements 201, 202 (and so a current can flow between the two contact elements 201, 202 via the connecting element 203).

FIG. 2A shows an exemplary contactor 110 in which the connecting element 203 as a whole can be moved by an actuator 204 away from the two contact elements 201, 202 (in the open state) or can be moved toward the two contact elements 201, 202 (in the closed state).

FIG. 2B shows an exemplary contactor 110 in which the connecting element 203 has a fixed first part 223 and a movable second part 224. The first part 223 is permanently in electrically conductive contact with the first contact element 201. The second part 224 of the connecting element 203 is permanently in contact with the second contact element 202. The second part 224 can be moved by an actuator 204 in order to bring about an electrically conductive connection between the first part 223 and the second part 224, and thereby to transfer the connecting element 203 to the closed state. On the other hand, the second part 224 can be moved away from the first part 223 by the actuator 204 in order to transfer the connecting element 203 to the open state.

The two contact elements 201, 202 can each be connected to a section of a power line such that the power line is electrically conductive or interrupted depending on the state of the connecting element 203. The actuator 204 of the contactor 110 can be connected to a control unit 101 for actuating the actuator 204 via control lines 214.

A temperature sensor 205 which is designed to record temperature measurement values with respect to the temperature of the connecting element 203, or at least a part 223 of the connecting element 203, can be arranged on the connecting element 203 of the contactor 110. The temperature sensor 205 can comprise a temperature-dependent resistor (for example an NTC or PTC resistor). The temperature measurement values can be provided via one or more temperature lines 215.

The contactor 110 is preferably designed such that at least a part 223 of the connecting element 203 can be used as a measuring resistor, in particular as a shunt resistor, for measuring the current flowing through the contactor 110. The part 223 of the connecting element 203 used as measuring resistor can be referred to as the measuring component 223 of the connecting element 203.

The contactor 110 can have a first measuring line 213 which is electrically connected to the first end of the measuring component 223 of the connecting element 203. The contactor 110 can furthermore have a second measuring line 213 which is electrically conductively connected to the opposite second end of the measuring component 223 of the connecting element 203. A voltage measuring unit (not illustrated) can be connected to the two measuring lines 213 in order to record a voltage measurement value of the voltage drop across the measuring component 223 of the connecting element 203. The voltage measurement value detected is dependent on the current intensity of the current flowing through the connecting element 203, i.e. through the contactor 110.

In the example illustrated in FIG. 2A, the entire connecting element 203 corresponds to the measuring component 223. In the example illustrated in FIG. 2B, the measuring component 223 corresponds to the fixed part 223 of the connecting element 203.

The contactor 110 can be designed in such a way that the resistance value of the ohmic resistance of the measuring component 223 is known in advance (and corresponds to a nominal value). This can be achieved by measuring the measuring component 223 in advance. Alternatively or in addition, this can be achieved by producing and/or selecting the measuring component 223 with a particularly low manufacturing tolerance with respect to the resistance value of the ohmic resistance.

During operation of the contactor 110, a control unit 101 can convert the voltage measurement values detected by the voltage measuring unit into measurement values for the current intensity of the current flowing through the contactor using stored characteristic data. The characteristic data can indicate the resistance value of the ohmic resistance of the measuring component 223 of the connecting element 203. The resistance value may possibly depend on the temperature of the measuring component 223. The temperature of the measuring component 223 can be determined using the temperature sensor 205. By taking the temperature of the measuring component 223 into account, the current flowing through the contactor 110 can be determined with particularly high accuracy.

As already stated, a contactor 110 should preferably be monitored and/or diagnosed during operation, as the contactor 110 can stick. A shunt resistor can be used for monitoring in order to record the current flowing through the contactor 110. The installation of a dedicated shunt resistor involves a relatively high outlay.

As described in this document, the busbar, i.e. the connecting element 203, of a contactor 110 can be used to enable efficient current measurement.

The contactor 110 can have a Lorenz force loop for actuating the busbar 203 (i.e. the connecting element 203) so that, at a relatively high current flow through the busbar 203, the holding force is increased (by self-amplification and/or levitation mitigation). In such a contactor 110, an additional busbar piece 223 may possibly be installed, this being particularly well suited as a measuring component 223 for measuring the current.

The shunt sensor system can be used for the purpose of contactor diagnostics. Closing can be identified, for example, by a voltage measuring unit installed on the measuring component 223 of the contactor 110.

Ageing identification via the development of the temperature in the contactor 110 can be made possible by virtue of a temperature sensor 205 on the measuring component 223. The temperature can preferably be measured directly at at least one contact element 201, 202 (which typically represents the hottest point of the contactor 110). This can be used, for example, to increase the performance of the system (for example of the vehicle 100) in which the contactor 110 is installed. In particular, existing temperature reserves can be exploited.

The contactor 110 can have a cooling system, in particular in order to keep the measuring component 223 at a defined temperature value. This allows the accuracy of the current measurement to be increased. The current carrying capacity of the contactor 110 can thus also be increased.

The resistances of the busbars 203, in particular the measuring components 223, can be measured during manufacture. It is then possible to select busbars 203, in particular measuring components 223, which have a low tolerance with respect to the resistance. These can then be installed in contactors 110 which have an integrated shunt resistor as measuring component 223 of the busbar 203.

Different variants of contactors 110 can be provided—those which have a measuring component 223 with a precisely defined resistance, and those which have a busbar 203 with an indeterminate resistance.

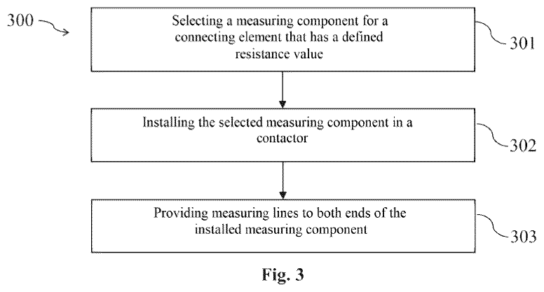

FIG. 3 is a flowchart of an exemplary method 300 for producing a contactor 110 which is designed as described in this document. The method 300 comprises selecting 301, from a set of possible measuring components 223, a measuring component 223 of the connecting element 203, wherein the measuring component 223 is selected in such a way that the measuring component 223 has an ohmic resistor with a resistance value which deviates from a predefined nominal value by no more than a predefined tolerance (for example of 10% or less, in particular of 5% or less).

The method 300 further comprises installing 302 the selected measuring component 223 in a contactor 110. In addition, the method 300 comprises connecting 303 different ends of the measuring component 223 to measuring lines 213 to record an electrical voltage dropping across the measuring component 223.

During manufacture of the contactor 110, a measuring component 223 of the connecting element 203 which has a certain resistance value can be selected. The resistance value can be measured explicitly. The measured resistance value can also be stored as characteristic data for the contactor 110. For example, the measuring component 223 and/or the contactor 110 can have a specific identifier, and the characteristic data can be stored together with this identifier.

A control unit 101 for controlling the contactor 110 can access the characteristic data with the resistance value of the ohmic resistance of the measuring component 223 during operation of the contactor 110 (based on the identifier). The characteristic data, as described in this document, can also be used to determine the current measurement value of the current flowing between the contact elements 201, 202 of the contactor 110.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A contactor, comprising
a first contact element and a second contact element;
an electrically conductive connecting element, wherein at least one measuring component of the connecting element is in the form of a measuring resistor;
measuring lines which are electrically conductively connected to different ends of the measuring component so that a voltage that drops across the measuring component due to a current flowing through the measuring component is measurable via the measuring lines; and
an actuator configured to move the connecting element between a closed state and an open state, wherein, in the closed state, an electrically conductive connection between the first contact element and the second contact element is effected via the connecting element, and wherein, in the open state, no electrically conductive connection between the first contact element and the second contact element is effected by the connecting element.

2. The contactor according to claim 1, wherein
the measuring component of the connecting element is configured such that the current flowing between the different ends of the measuring component corresponds to a current flowing between the first contact element and the second contact element.

3. The contactor according to claim 1, further comprising:
a temperature sensor configured to record temperature measurement values in relation to a temperature of the measuring component of the connecting element; and
one or more temperature lines to the temperature sensor to provide the temperature measurement values of the temperature sensor.

4. The contactor according to claim 3, further comprising:
a temperature control unit configured to control the temperature of the measuring component of the connecting element.

5. The contractor according to claim 4, wherein the temperature control unit is configured to cool and/or heat the measuring component.

6. The contactor according to claim 1, wherein
the connecting element has a fixed part and a movable part;
the actuator is configured to move the movable part of the connecting element in order to move the connecting element between the closed state and the open state; and
the fixed part of the connecting element comprises the measuring component of the connecting element.

7. The contactor according to claim 1, wherein the measuring component is an entirety of the connecting element.

8. The contactor according to claim 1, wherein
the contactor has a specification;
in the specification, a nominal value of an ohmic resistance of the measuring component of the connecting element is specified with a tolerance; and
the tolerance is 10% or less.

9. The contractor according to claim 8 wherein the tolerance is 5% or less.

10. A system, comprising:
a power line; and
a contactor according to claim 1,
wherein the contractor is arranged so as to interrupt the power line by virtue of the connecting element of the contactor being moved to the open state.

11. The system according to claim 10, further comprising:
a voltage measuring unit configured to record a voltage measurement value of the voltage on the measuring lines of the contactor; and
a control unit configured to determine a current measurement value of the current flowing between the contact elements of the contactor on the basis of the voltage measurement value and using characteristic data,
wherein the characteristic data indicate a resistance value, determined in advance, of an ohmic resistance of the measuring component of the connecting element of the contactor.

12. The system according to claim 11, wherein
the contactor comprises a temperature sensor configured to record temperature measurement values in relation to a temperature of the measuring component of the connecting element;
for a large number of different temperature measurement values, the characteristic data in each case specify a resistance value of the ohmic resistance of the measuring component of the connecting element of the contactor; and
the control unit is configured to determine the current measurement value based on the temperature measurement value and based on the characteristic data.

13. A method for producing a contactor having a first contact element and a second contact element, an electrically conductive connecting element having a measuring component in the form of a measuring resistor, and measuring lines,
the method comprising:
selecting from a set of possible measuring components a measuring component of the connecting element which has an ohmic resistor with a resistance value which deviates from a predefined nominal value by no more than a predefined tolerance;
installing the selected measuring component in the contactor; and
connecting different ends of the measuring component to the measuring lines in order to record an electrical voltage dropping across the measuring component.
